(19) United States
(12) Patent Application Publication
(10) Pub. No.: US 2002/0010655 A1
(43) Pub. Date: Jan. 24, 2002

(54) Real time, three-dimensional, configurable, interactive product display system and method

(75) Inventor: Jan Kjallstrom, Monarch Beach, CA (US)

Correspondence Address: Sharmini N. Green, Esq., Riordan & McKinzie, 29th Floor, 300 South Grand Avenue, Los Angeles, CA, 90071, US

(73) Assignee: REALITYBUY, INC.

(21) Appl. No.: 09/866,070

(22) Filed: May 25, 2001

Related U.S. Application Data
(60) Provisional application No. 60/207,557, filed on May 25, 2000.

(51) Int. Cl. G06F 17/60; G09G 5/00

(52) U.S. Cl. 705/27; 345/6

(57) ABSTRACT

A real-time, three-dimensional, interactive, configurable product display system and method is disclosed. An interactive interface configures and displays products in real-time. The interface comprises a search mechanism that retrieves a product from a data repository according to predefined criteria and a three-dimensional viewer displaying a threedimensional view of the product. The interface may also include a two-dimensional viewer displaying a two-dimensional view of the product. The two-dimensional view of the product corresponds to the three-dimensional view of the product. Additionally, an interactive method is disclosed for configuring and displaying a product display in real-time. The method comprises the steps of retrieving a product from a data repository in response to input from a user, configuring the product in real-time according to instructions from the user; and displaying a three-dimensional, real-time view of the product.

### BACKGROUND OF THE INVENTION

1. Field of Invention

The present invention relates generally to a real-time, three-dimensional, configurable, interactive product display system and method.

2. Description of Prior Art

Many merchants today provide online catalogs to enable consumers to browse through their products and/or services online. These catalogs may be available in the store, at kiosks or in-store computer terminals, or in some instances, via the Internet. (All references to “online catalogs” in this specification shall mean electronic catalogs available via the Internet and/or standalone computer terminals or kiosks) These electronic catalogs have traditionally been two-dimensional (“2D”) displays, similar to traditional print catalogs. Thus, for example, a consumer who wishes to buy a desk for his or her home office may see a 2D representation of the desk in the electronic catalog. This 2D representation does not provide the consumer with any ability to connect (i.e., associate) with the product. The consumer may not, for example, examine the features of the desk. Neither can the consumer determine whether the desk will properly fit in his or her home office or match the decor of the office. In order to interact with the item in any way, the consumer must go to a store, physically examine the desk, determine whether the dimensions of the desk will fit in his or her home office, then purchase the desk and take it home to determine if the desk does in fact fit in the home office and/or whether the desk matches the decor of the office.

In recent years, businesses have endeavored to increase the procurement connectivity of their online catalogs. Various approaches have been widely used to deliver product information, specifically over the Internet. Sellers have attempted to creatively display and describe their products to customers using their web pages. Manufacturers have laid out and displayed product catalogs on web pages having content, such as text, pictures, sound and video. The technologies for delivery of product images in online catalogs employ images of photographs and artistic renderings (including those that are computer generated). These images are delivered to the customer as photographs, pictures, stitched 2D pictures where multiple images are used to deliver a scrolling panorama, canned or streaming 2D media including video and canned or streaming 3D pictorial objects (e.g., stereographics). More recently, collections of photographic images are provided that permit the customer to view the product from different vantage points through photographic images taken from those vantage points.

For customers with Internet access, catalog web pages may be stored for later display on a web server that responds to Hypertext Transfer Protocol (HTTP). A catalog web page is accessed using a browser, e.g., Netscape® Communicator or Microsoft® Internet Explorer. In response to a customer query, a browser requests a catalog page from a web server using HTTP. The web server responds to the request by returning the catalog page using HTTP. The web page is typically encoded using HyperText Markup Language (HTML). The browser interprets the HTML to format and display the catalog pages.

A great variety of enhancements to HTML are available, and many of those implement the image deliveries previously discussed. An online catalog can use these enhancements by embedding in its HTML codes references to these enhanced image files. To correctly present these files and their enhanced interface, the browser must often be configured with an appropriate plug-in. When encountering an HTML enhancement for the first time, most modern browsers are configured to query the browser user if the download of an appropriate plug-in is desired. If directed to do so, the browser searches a master list of available plug-ins and begins a download. After successful download and installation of an appropriate plug-in, subsequent encounters with that type of HTML enhancement will be correctly rendered in the catalog page. Popular plug-ins include Adobe's Acrobat Reader® and Apple Computer's QuickTime® and QuickTime VR®. These enhanced image viewers permit the customer to view products and components according to the predetermined images provided. Customers may browse through a catalog to identify products of interest, to obtain specific product information and to electronically purchase products after reviewing product information. Yet, there still is no interactivity between the product and the customer online; the customer may not pick up, freely turn and manipulate a product, and/or customize a product in real-time to suit his or her needs.

The prior art also does not allow users to create products and/or showrooms for displaying products and components as three-dimensional (“3D”) displays in real-time. Prior art products also do not link to data repositories external to the product to access product information and other related data. Moreover, prior art products do not allow users to manipulate 3D products and components in 3D and view them from different positions, either as stand-alone products or as products in a showroom environment. There also does not exist the ability to simultaneously view both a 2D and 3D view of products, where manipulating one view of the product will also in real-time similarly manipulate the other view.

In products such as “3D Home Interiors” by Broderbund, for example, although users may select home furniture and arrange it in a 2D view, there is no means by which the user may actually create a customized room, including the dimensions of the room and the objects placed in the room. The user also cannot configure any selected piece of furniture with customized features. These products also do not allow for manipulation and display of the selected items in real-time. Instead, objects only move in the 2D window, and the view is then “reset” in a 3D window. There is no immediate real-time feedback in the 3D view as a user manipulates objects in the 2D view. Users still may not examine a particular object in detail, and there is no ability to interact with or try out the features of the objects (e.g., open cabinets, open drawers, tilt chairs back, etc.). Further, there is no HTML or other application language real-time link, direct buying link and/or the ability to show the user the pricing impact of decisions. Such prior art products lack any ability to integrate effectively with a merchant's internal and/or external data repositories. A data repository for the purposes of this specification shall include, but not be limited to, databases, files, and product systems such as pre-configured systems, Enterprise Resource Planning (“ERP”) systems and/or e-commerce systems.

Other prior art products do exist that provide users with 2D views of products and/or product showrooms. These prior art products do not, however, have any ability to present real-time information to customers. Neither is there any ability in these products to link the products and/or product showrooms to any external data repositories or that use the Internet. The same limitations exist for products that enable users to view 3D images of products. The images in these products are generally rendered on a server and simply displayed on a user's computer. If a user requests a change to the product, the change does not occur in real-time. Instead, the server re-renders the product according to the changes requested by the user and re-submits the display to the user. The types of changes available to a user are also significantly limited. For example, a user may be able request a change of the color of wood for a desk that he or she is viewing, but prior art products do not generally provide users with the ability to customize any and all portions of the desk, such as removing and/or adding drawers to the desk.

In view of the foregoing, there is a need for a real-time, three-dimensional, interactive, configurable product display system and method that overcomes the deficiencies of the prior art.

### SUMMARY OF THE INVENTION

The present invention discloses a real-time, three-dimensional, interactive, configurable product display system and method. Specifically, the present invention discloses an interactive interface for configuring and displaying products in real-time. The interface comprises a search mechanism that retrieves a product from a data repository according to predefined criteria, and a three-dimensional viewer displaying a three-dimensional view of the product. The interface may additionally includes a two-dimensional viewer displaying a two-dimensional view of the product. The two-dimensional view of the product corresponds to the three-dimensional view of the product.

Additionally, the present invention discloses an interactive method for configuring an electronic product display in real-time. The method comprises the steps of retrieving a product from a data repository in response to input from a user, configuring the product in real-time according to instructions from the user, and displaying a three-dimensional, real-time view of the product.

### BRIEF DESCRIPTION OF THE DRAWINGS

The present invention is illustrated by way of example and not limited in the following drawings, in which like references indicate similar elements, and in which:

FIG. 1 illustrates a simulation component description of the system and method of the present invention.

FIG. 2A illustrates an exemplar of one possible sequence being initiated by a user to begin use of the system and method of the present invention.

FIG. 2B illustrates an exemplar of the product choices as selected in FIG. 2A and the showroom features as selected.

FIG. 3 illustrates an exemplar of how a user can select a product in a scrollbar located in the web enabled language and/or other application language section of the interface.

FIG. 4 illustrates an exemplar of how a user can select and configure styles of product components.

FIG. 5 illustrates an exemplar of how a user can select the types and quantity of products.

FIG. 6 illustrates an exemplar of how a user can select a product and manipulate its orientation.

FIGS. 7A-B illustrate exemplar of how a user can reposition products in the showroom invention.

FIG. 8 illustrates an exemplar of how a user can select a product from the 3D viewer.

FIGS. 9, 10A-B illustrate an exemplar of how a user can obtain a detailed view and interaction with a selected product.

FIGS. 11A-B illustrates exemplar of how a user can select and control the view angle of products.

FIGS. 12A-B illustrates exemplar of how a user can set the dimensions of the interactive showroom display, determine the measurements of the showroom and visualize the impact on the arrangement of the products located within the showroom's dimensions.

FIGS. 13A-B illustrate exemplar of how a user can elect to print out an image of the 2D layout of the products as configured and selected.

### DETAILED DESCRIPTION OF THE INVENTION

The present invention discloses a real-time, three-dimensional, interactive, configurable product display system and method. In the following description for the purposes of explanation, numerous specific details are set forth in order to provide a thorough understanding of the present invention. It will be evident, however, to one skilled in the art, that the present invention may be practiced without these specific details. In other instances, detailed descriptions of well-known methods and devices are omitted so as not to obscure the description of the present invention with unnecessary detail.

The present invention enables a user (via the Internet, World Wide Web, intranet, local area network, stand-alone system and/or an in-store computer) to create and enter an interactive, configurable, virtual product to view, evaluate in real-time, and purchase products. The virtual products may be viewed as individual stand-alone products, or as products and/or collections of products within the context of a showroom. If the user selects an individual product such as a motorcycle, for example, the user may select various components for the motorcycle and view 2D and/or 3D images of the new selections in real-time. Within the context of a virtual showroom, the user may simulate any space, select and configure products within that space and similarly interact, navigate and view product selections simultaneously in 2D and/or 3D representations. In either situation, the user may save the product configuration and/or print out the configured layout. Event signals are sent between one or more data repositories that store the information regarding the products, a 3D viewer and a multimedia viewer, and web enabled language and/or other application language, such as Visual Basic, Java and/or C++. These event signals cause changes to be displayed in real-time. 3D models may be viewed in a 3D viewer and as 3D images and/or photographs, 2D renderings or other in the multimedia viewer or by using web enabled language and/or other application language. A multimedia development tool (such as Macromedia Director or similar products) and application development tool (such as Visual Basic, Visual C++ or JBuilder) are utilized to facilitate communication of event signals and other data. The interactive simulations are created by using 3D models and 3D defined objects by using real time rendering software such as EON Studio or other similar products.

To assist in the decision making process, the user may, in real-time, define a 3D representation of a product, including any customized changes that the user would like to make to the product. Additionally, or alternatively, the user may also, in real-time, define a 3D representation of the showroom setting into which the products will ultimately be placed, including the physical dimensions of the destination site (e.g., office or cubicle), select the wall color, flooring surface and color, place windows and doors, as well as other viewing choices. Users may then select the product they desire to view, change the colors and materials of the product(s), and add features to each product. Users have virtually unlimited ability to manipulate the products in the viewing area as many times as they elect to see how their specified product combinations appear in the physical context as both 3D and 2D images.

The invention also allows the user to test out the functionality of the products by utilizing interactive 3D product models. As the user specifies a particular individual product or combination of products, the system and method of the present invention enable access to appropriate databases to calculate the selling price of the user's product choices and provide an estimated delivery schedule. Once the user has identified their final configuration or combination of products, the user can either place their product order through an online procurement system, accept as-is the quoted price and delivery, save their product selections and email it to a sales associate at a local physical retail operation to enter into negotiation, or if the user is viewing the information at an in-store computer terminal, place the product order directly with the sales associate(s) at the store.

The present invention will forever change the way product buyers and sellers interact and conduct transactions. Regardless of the type of product, the present invention alleviates the need for a buyer to travel to a physical showroom to view, select or buy a product. It allows buyers to see products, try them out and execute product purchases in a meaningful context, with the click of a mouse, touch of a screen, or other interactive tool. According to embodiments of the invention, the products include, but are not limited to furniture, kitchen equipment, automobiles, motorcycles and industrial components.

The present invention enables an entirely new paradigm for communicating and demonstrating product information. Product sellers today may only describe product features by using multiple images in a print or online catalog. The present invention not only allows all features of a product to be displayed in a single interface, it also enables product sellers or purchasers to instantly change and reconfigure the product in real-time. Utilizing the system and method of the present invention, the product seller or purchaser will instantly be presented with a 3D, fully-interactive and customized version of the product.

The present invention may be deployed as an on-line Internet and/or web-based solution, or as freestanding displays and/or terminals. For example, by using in-store, large screen displays, a product retailer can present a full array of its product offerings without having to maintain a physical inventory on the floor or in the warehouse. According to one embodiment of the present invention, customers may utilize an in-store terminal to simply examine a product with various customized features. Alternatively, the customer may simply be interested in seeing how their product choices will look in their own environment. The customer's ability to examine the product features and/or determine how the product will look in their own environment accelerates the decision-making process by reducing uncertainty.

According to one embodiment of the present invention, a real-time, 3D, interactive, configurable showroom display system and method are provided based on the use of 3D simulation objects. Simulation objects provide a 3D model of a product or component. A simulation object may include codes for its own manipulation, or for its interaction with other simulation objects. Simulation objects are typically rendered from polygons, textures, colors, rules of behavior (e.g., equations of motion, physically based modeling) and the like. An Internet simulation object viewer is preferably configured as a plug-in for a browser. This allows a customer to orient and interact with simulation objects from within their browser, by using input devices such as a keypad, mouse, touch sensitive screen or other input device. Simulation objects may be moved and re-oriented with respect to the customer, or the objects can remain stationary and the customer can move around them. Simulation objects may be taken apart or components may be added. Simulation objects may be manipulated. A close, intuitive relationship is created between the customer and the displayed simulation object because of the interactivity and the simulation objects in context.

Use of simulation objects provides a method for exploring and examining products and phenomena in a natural and intuitive way that exploits man's highly developed skills in visual recognition. 3D spatial processing capabilities are matched with the computer's representation of objects. Use of the system and method of the present invention conveys to a customer a level of personal presence with a remote product. A visually-coupled system is created that presents the products alone, as part of other products, and/or in various real-world environments. Unique product offerings are showcased through visualization, configuration and selection. For many products, it is desirable to ensure that the individual components of a product fit together or interact in a manner to meet the customer's needs. A customer may need to visualize a product within a certain context of its relationship to other products and to the visual space, and the attributes of each product individually. Dynamic computer graphic displays of simulation objects help buyers gain the understanding of how various products in the showroom display interact with each other. Provided is the ability for the customer to see the products, both individually and in context of other products and the showroom environment and to interact with the products before the purchase. Thus, the present invention addresses the need for an interactive method for improving product information transfer from seller to buyer, to improve procurement connectivity and obtaining increased procurement functionality by providing a process for interactively displaying components and products for sale.

Customers can establish a bidirectional communication link, preferably log into the system, then browse among simulation objects of available components and products, interact with the components and products through the proxy of their simulation objects, and ultimately place an order online, either via the Internet or via a stand-alone terminal. The system merges interactive 3D simulation objects of the products with information about the products and creates a 3D viewable object for viewing and manipulating by the customer. The system also places the 3D simulation objects of the products into a multiple viewing panel display and interacts with 2D images and data.

Simulation objects implemented in an online product catalog, either on the Internet or a stand-alone terminal, provides for extensive customer interaction with the products being offered. By making products and components available as simulation object representations, a higher-quality and more precise product evaluation of the products is possible and the procurement process is enhanced. The object is manipulated independently or as part of a group of objects or components. This significantly enhances the customer's ability to understand the product information, to perceive the product, and to visualize the product and/or all of its individual components in the context of their relationship to other products or by themselves.

A web-based or Internet method for product procurement consistent with the present invention may be initiated by a customer requesting of information at a terminal connected to the Internet. The customer may access the information requested through a server maintained by a merchant. The request in turn is directed to either an internal or external server, which invokes the system and method of the present invention. The customer is logged in to a web page that is the starting point for each session. The customer is provided with an interface from which all the major functions of the merchant's system can be reached. From the interface the customer may select various components and products of interest to the customer. The customer's selection information is processed by the merchant's server.

Stand-alone terminals may interact with either internal data repositories, at a merchant's site, or with external data repositories, maintained by third parties. For stand-alone terminals that interact with internal data repositories, the terminals may be persistently connected to a data repository, thus always having access to updated information. Alternatively, the terminal may not be persistently coupled to a data repository, but instead connect to the data repository periodically to update information available to the terminal.

In the present invention, the simulation objects of the components and products are preferably stored as data in a data repository and provided on demand to the customer via the Internet or stand-alone terminal. According to one embodiment of the present invention, the data repository is a relational database. In this embodiment, the system interfaces with the database to access, transfer and display product information. A database management system (DBMS) is used to build the database and to operate on data within the database. The DBMS stores, retrieves and modifies data associated with the database. Alternative embodiments of the present invention may utilize various types of data repositories other than relational databases.

Simulation objects of components and products from the database include update dynamics to provide that the changes of the properties (position, orientation, configuration, etc.) of the objects appear to the customer to be in real-time (i.e., the behaviors of the simulation objects appear realistic). In addition, audio feedback may also be provided.

The customer receives fully interactive and configurable simulation objects depicting the components or products. In addition, the customer may be provided with a hybrid of traditional images enhanced by simulation objects. Various points within or behaviors of the simulation objects may be linked to sound or video. Once the viewer has manipulated the product and component images, he or she may select to purchase it. The customer then provides the information necessary to process the transaction.

In one embodiment, this system and method may also be linked to an online procurement system. In an alternate embodiment of the present invention, a single server is provided that implements multiple online catalogs that appear discrete. The server communicates bi-directionally with customers and, to and from it, information flows for products from more than one merchant. Requests for product viewing are associated with a particular merchant based upon the online storefront visited by a customer or upon the credentials presented by a merchant. Requests result in merchant specific product information being presented. In yet another embodiment of the present invention, users access product information from a stand-alone terminal at a merchant's store.

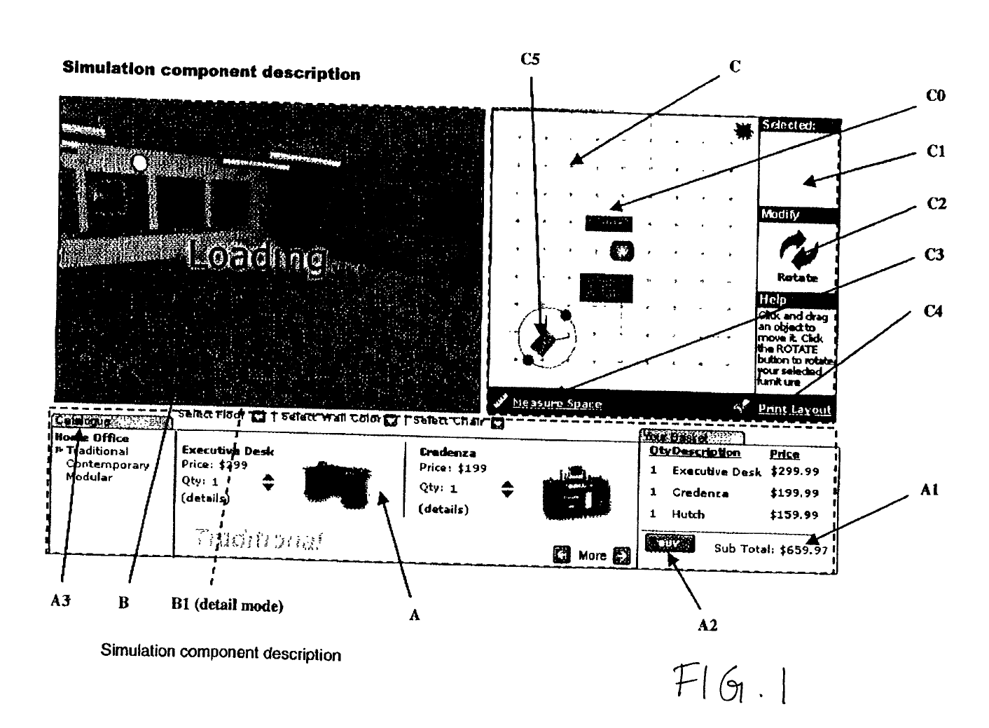

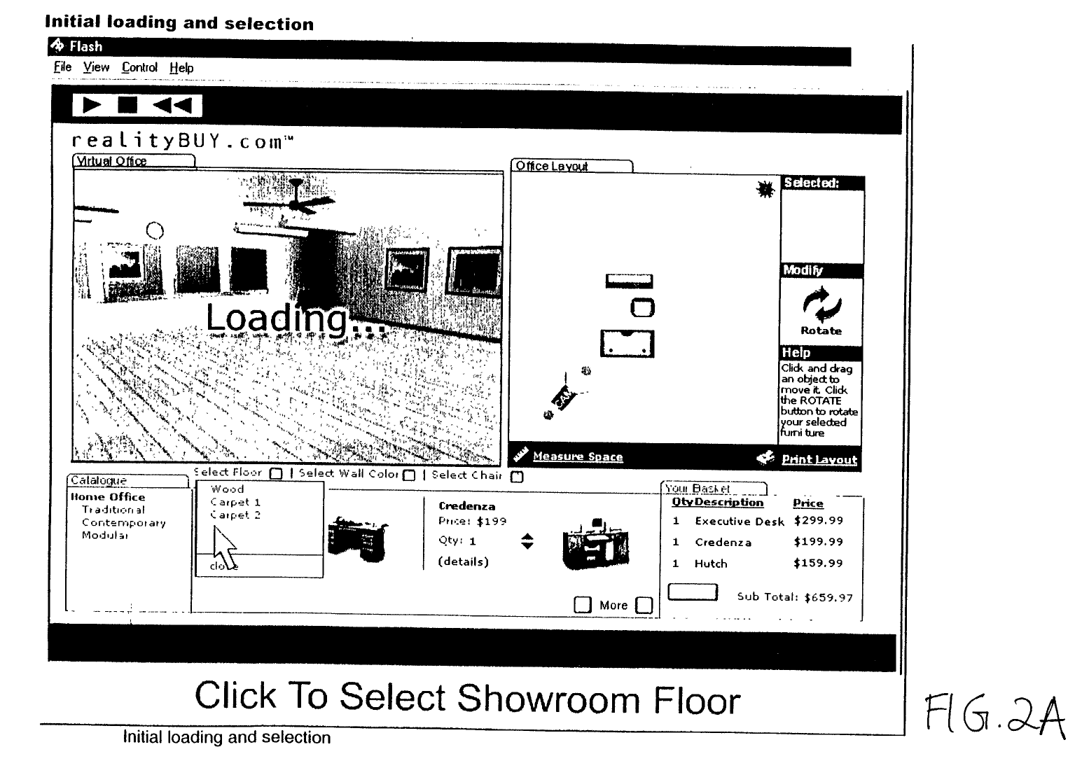

The following figures illustrate an interactive showroom display system and method according to the present invention. FIG. 1, entitled “Simulation component description,” illustrates a simulation component description of an interactive showroom display system and procurement system and method implemented over the Internet, intranet, local network or stand-alone system consistent with the present invention, which shows an application window generally divided into three sections, running in real-time and linking web enabled language and/or other application language noted as “A” (such as HTML, XML or similar); “B,” a three dimensional (“3D”) viewer (such as EON, Metastream or other); and “C,” a multimedia viewer (such as Shockwave or other). Although in this embodiment, the application window includes three sections, in alternate embodiments the application window may include more or less sections.

FIG. 1 illustrates “A1” indicating the total price for all selected products, in this case office furniture. Alternate embodiments of the invention may be used for various other product configurations including but not limited to kitchen hardware, automobile accessories, industrial components or other products); “A2,” the real time link to the procurement system to place a purchase order; “B1,” the ability to view and interact with any single product in enhanced detail; “CO,” a “top down” view of the layout of the objects and the location where the objects can be moved by the user in real time; “C1,” the visual image of the product selected by the user; “C2,” a manipulation device whereby the user can rotate the products in the viewer; “C3,” a “click and drag” system whereby a user can measure and artificially set the parameters of the outside dimensions of the showroom; and “C4,” whereby a user can print out the current layout of the objects as organized and placed by the user.

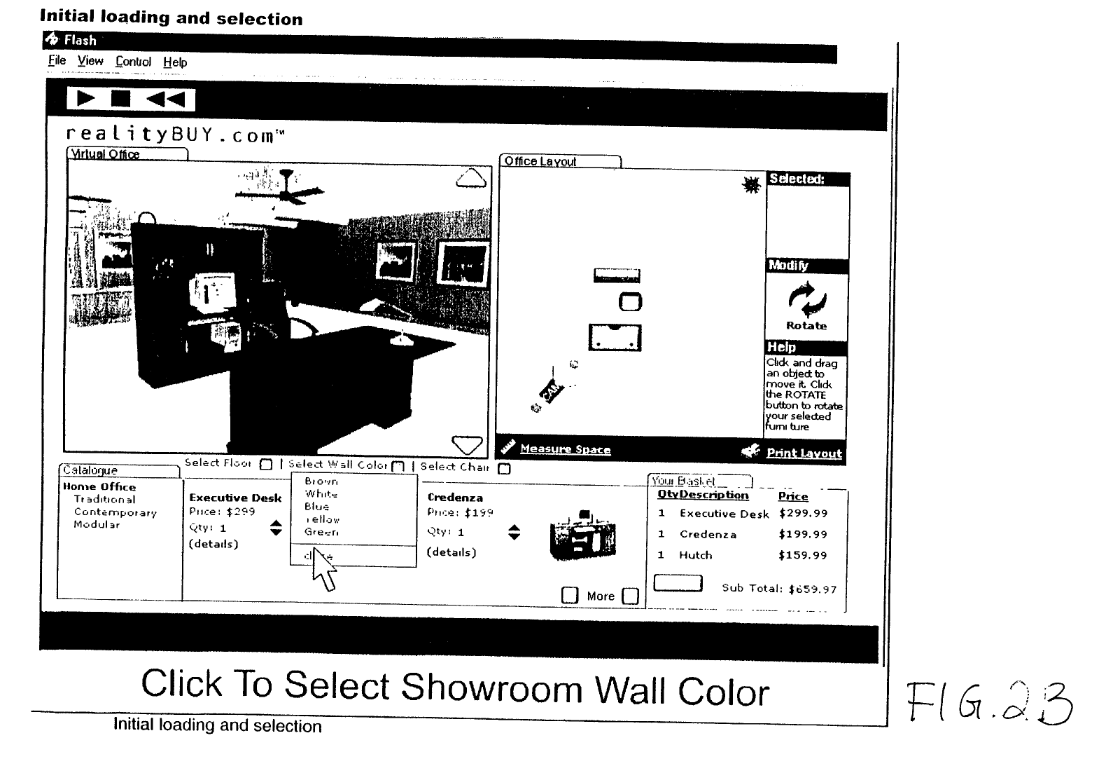

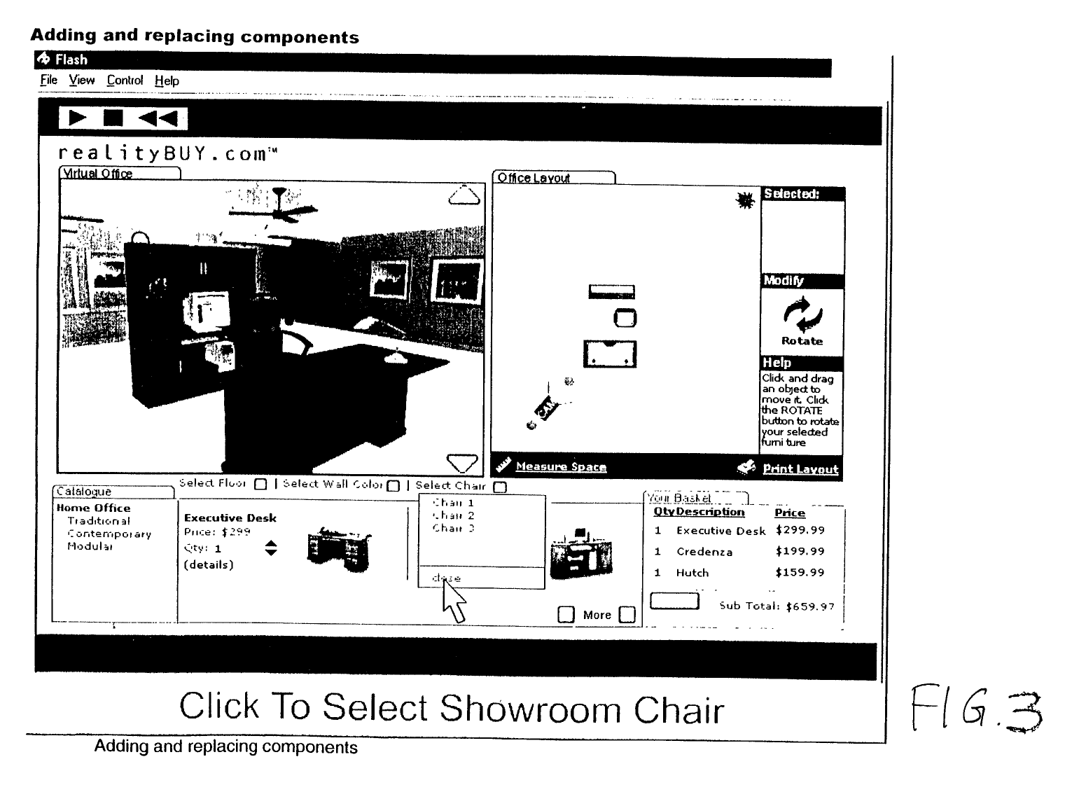

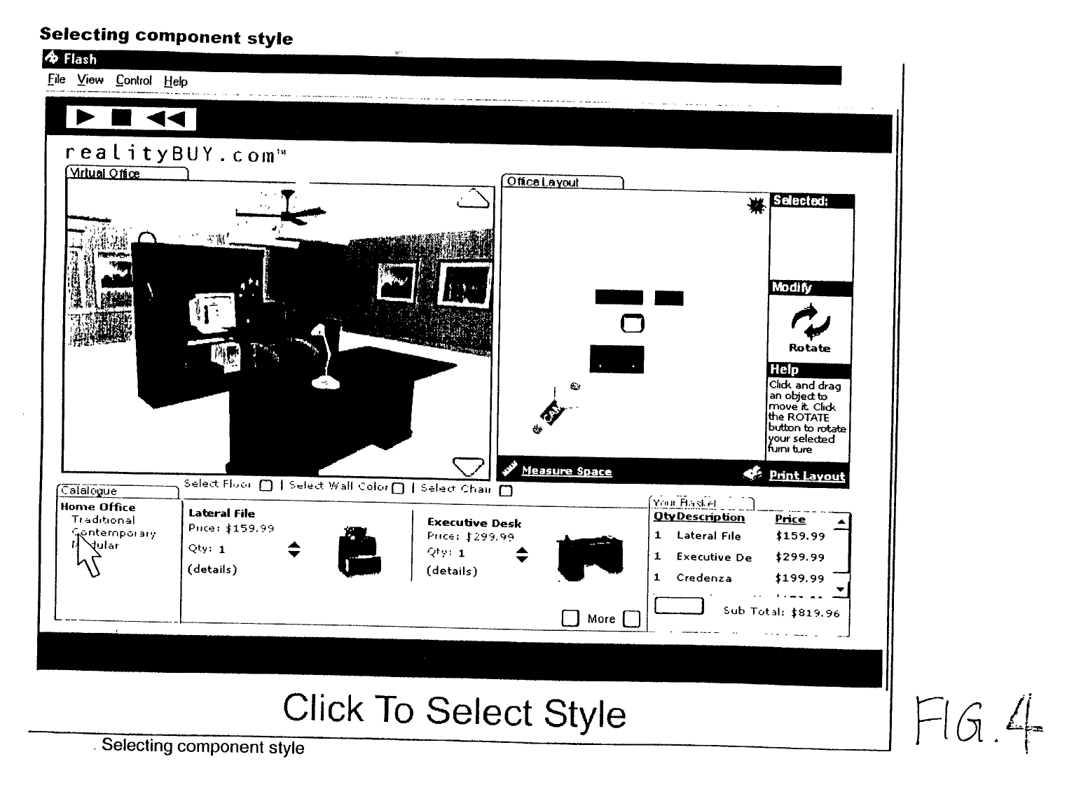

FIG. 2A, entitled “Initial loading and selection,” is an exemplar of one possible sequence being initiated by a user to begin use of the invention. If the user has not already done so, the user begins the use session by downloading necessary technology, including web enabled language and/or other application language, a 3D viewer and a multimedia viewer. The invention then begins by loading an empty room into the 3D viewer and a 2D image of the room into the multimedia viewer. The invention then automatically loads certain default 3D objects from the web server or intranet or local network or stand-alone system into the showroom with default settings. The user can select certain options in the web enabled language and/or other application language portion of the event (e.g., in this example the user has selected “traditional” home office furniture and “carpet 2” as a floor covering), which selection is then communicated in real time to the 3D viewer, multimedia viewer and database as an event sent and received. The 3D viewer then produces the 3D objects as requested.

FIG. 2B, also entitled “Initial loading and selection,” is an exemplar of the product choices as selected in FIG. 102a and the showroom features as selected. FIG. 2B also indicates the ability of a user to select wall color (e.g., in this example “green”). The multimedia viewer displays the top view placement of the products as selected;

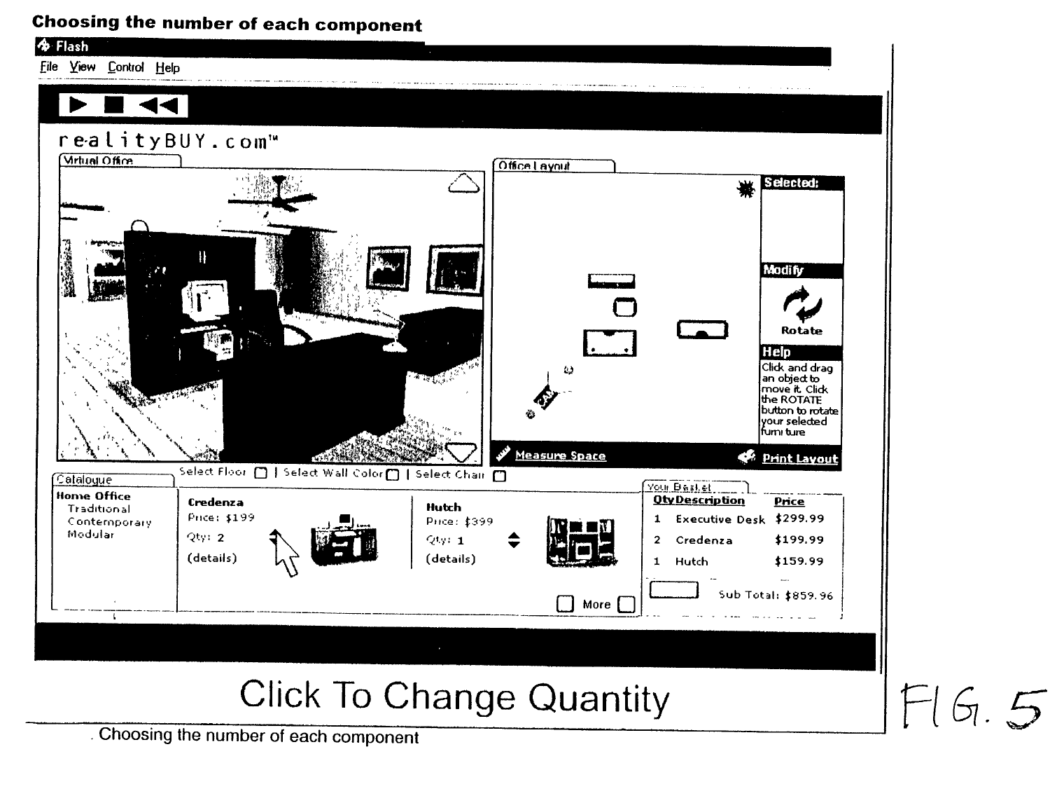

FIG. 3, entitled “Adding and replacing components,” is an exemplar of how a user can select a product (e.g., “chair 2”) in a scrollbar located in the web enabled language and/or other application language section. This selection event then causes the web enabled language and/or other application language to send notice of the event to the database, the 3D viewer and to the multimedia viewer in real time and, when received, 3D and 2D images of the product are then displayed in real time. A user can select to left “click” on the 2D image or right “click” on the object in the 3D viewer in the multimedia viewer, which then sends notice of the event to the 3D viewer, which then in real time produces a detailed interactive 3D simulation of the selected product and a detailed image with a product description. The web enabled language and/or other application language is updated in real time to retrieve data from a database, calculate and display the quantification and pricing effect of the user's product selections (e.g., in this figure the items in “Your Basket” are updated in real time to show all furniture selected, the quantity of items and the prices, and the total price).

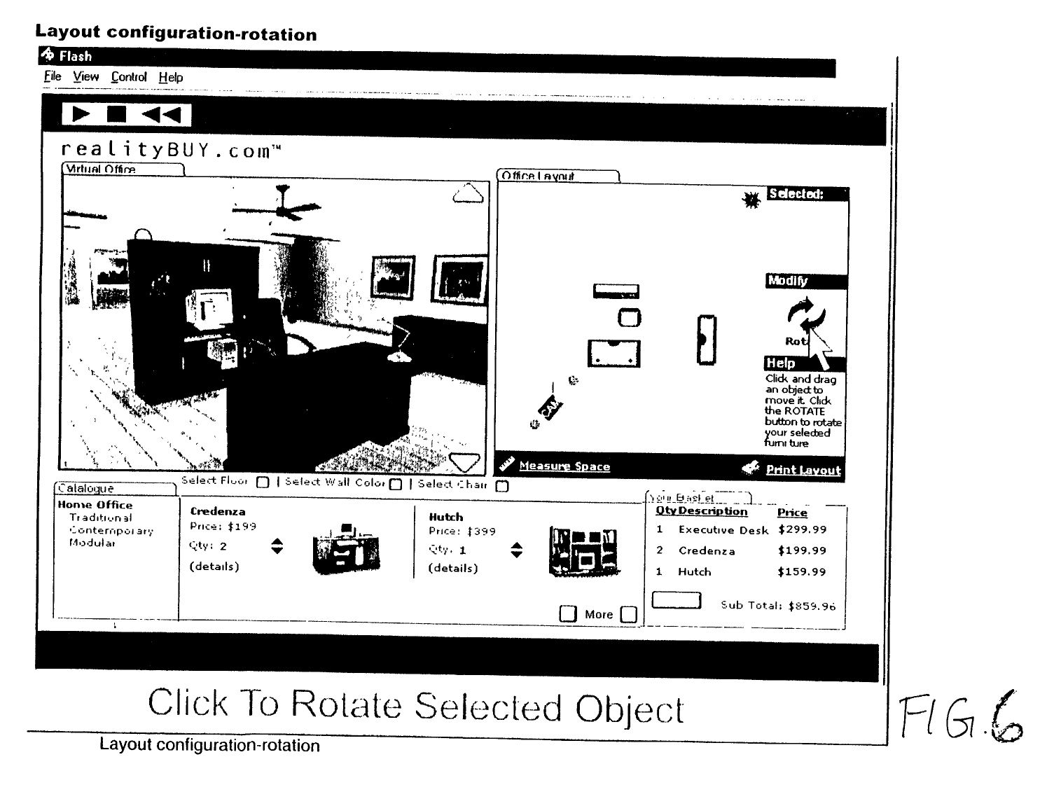

FIG. 4, entitled “Selecting component style,” is an exemplar of how a user can select and configure styles of product components. The user initiates the selection in the web enabled language and/or other application language (e.g., to select “contemporary” home office from the invention's catalogue component) which then sends notice of the event to query the database, the 3D viewer and the multimedia viewer. The 3D viewer then loads the object from a database server or locally to place the selected product in the selected style in the 3D viewer. The product is also produced in a 2D representation in the multimedia viewer. The web-enabled language and/or other application language updates the quantity and pricing (e.g., “Your Basket”) in real time. Products can also be selected by connecting to other pre-configured systems, ERP or e-commerce systems.

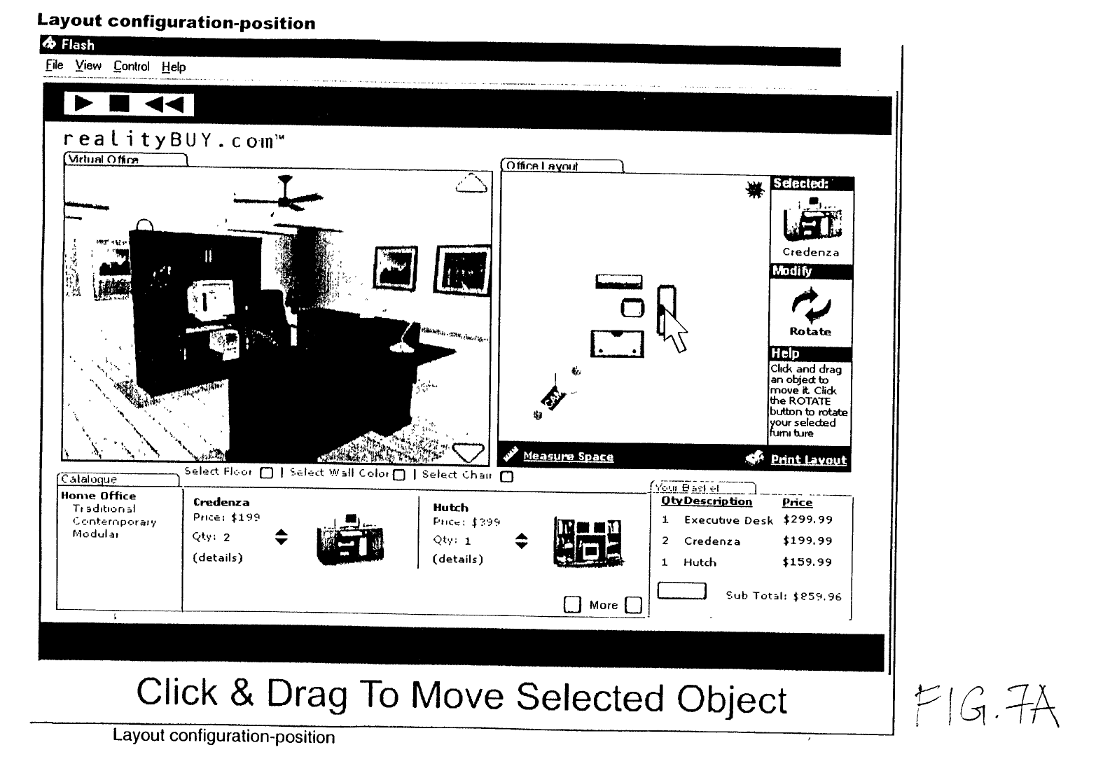

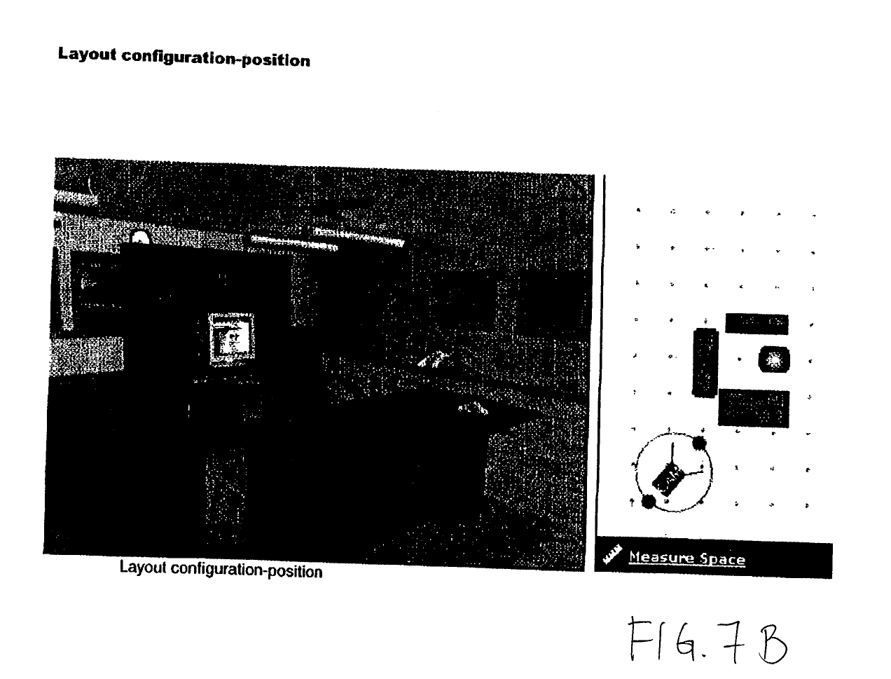

FIG. 5, entitled “Choosing the number of each component,” is an exemplar of how a user can select the quantity of products. The user initiates the selection in the web enabled language and/or other application language (e.g., by using an indicator to select the number of items selected), which sends notice of the event to the 3D viewer and the multimedia viewer. The 3D viewer then loads the object from an Internet server database, intranet server database, local network database, stand-alone database or locally to place the same quantity of selected product(s) in the 3D viewer (e.g., two credenzas were selected and two appear in both the 3D viewer and the 2D multimedia viewer). The product is also displayed in a 2D representation in the multimedia viewer and shows how the selected objects are positioned. The web enabled language and/or other application language updates the quantity and pricing (e.g., “Your Basket”) in real time.

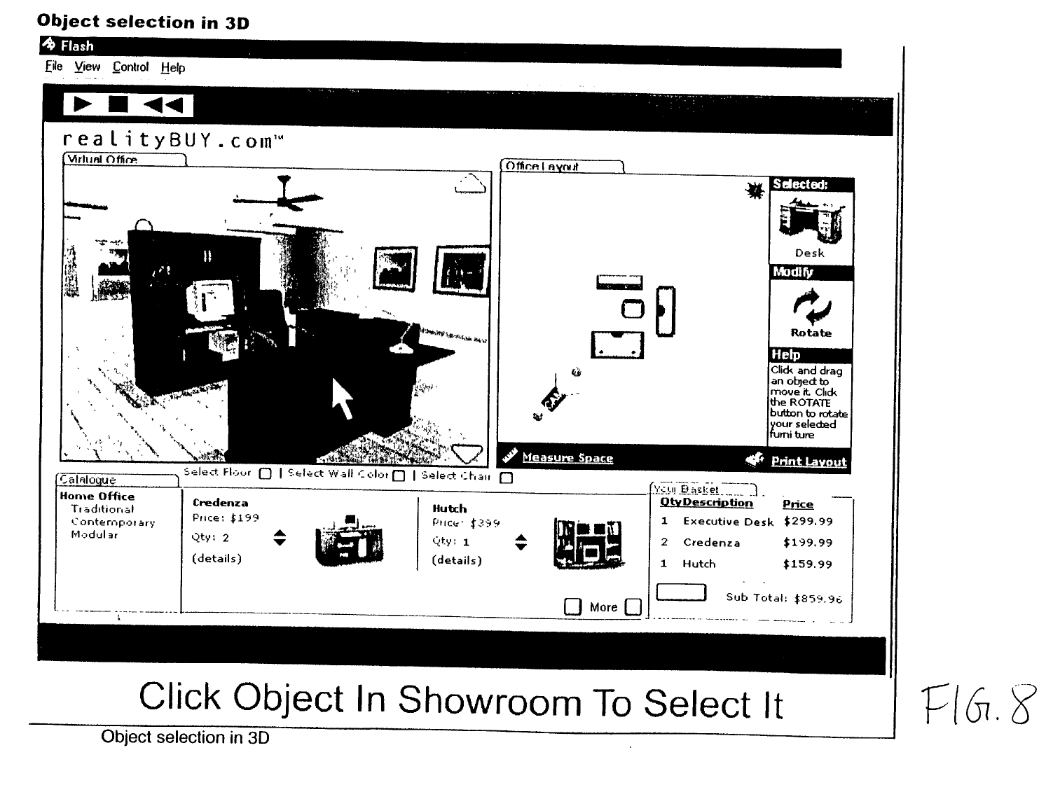

FIG. 6, entitled “Layout configuration-rotation,” is an exemplar of how a user can select a product and manipulate its orientation. The user can select a product in the multimedia viewer by left clicking on the object or in the 3D viewer by left clicking on the object and then the selected product will be displayed in “C1” (see FIG. 101). When the selected the object is highlighted (e.g., a red border appears around the product). The user can then manipulate the selected product by using rotation controls in “C2” (see FIG. 101). An event signal is sent from the multimedia viewer to the 3D viewer and the “CO” (see FIG. 101) portion of the multimedia viewer. The 3D viewer then receives the event notice and in real time updates the orientation of the product in the viewer in accordance with the rotational directive initiated by the user.

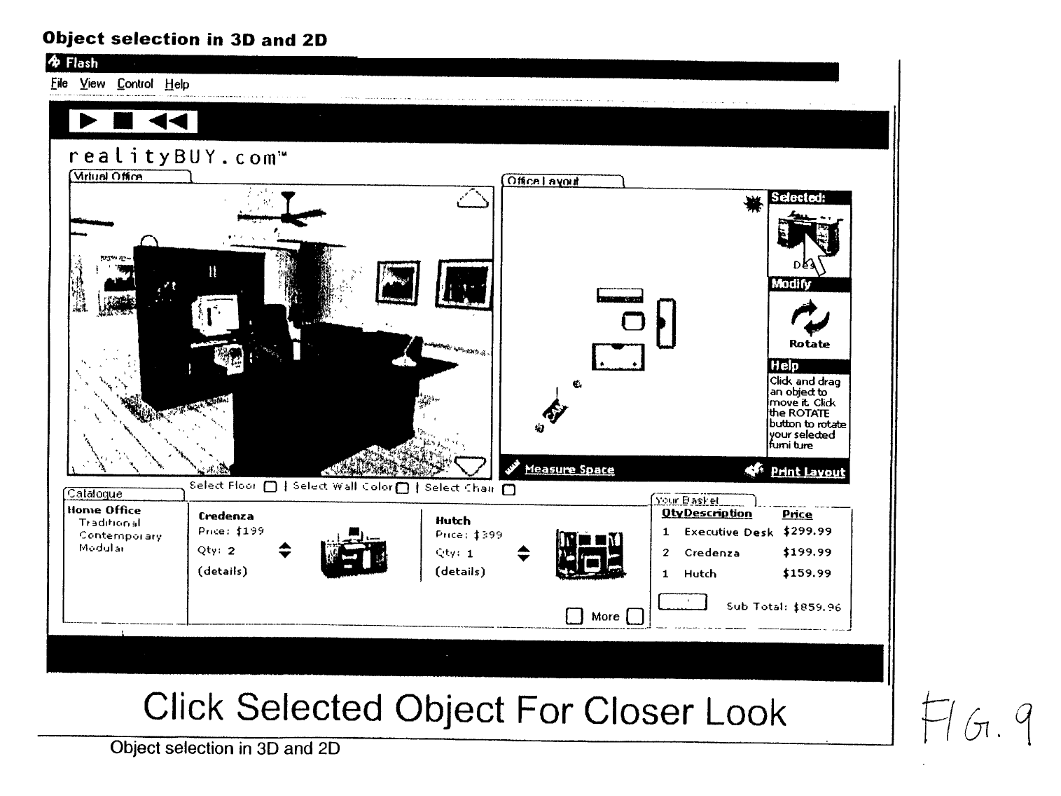

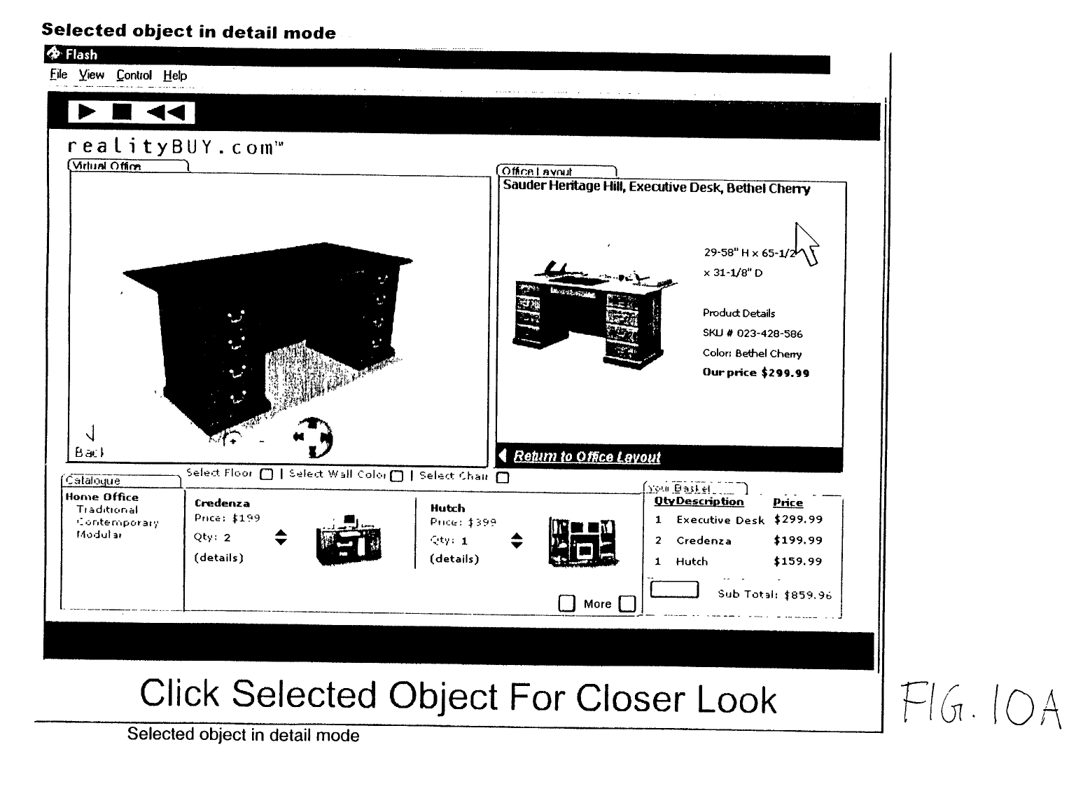

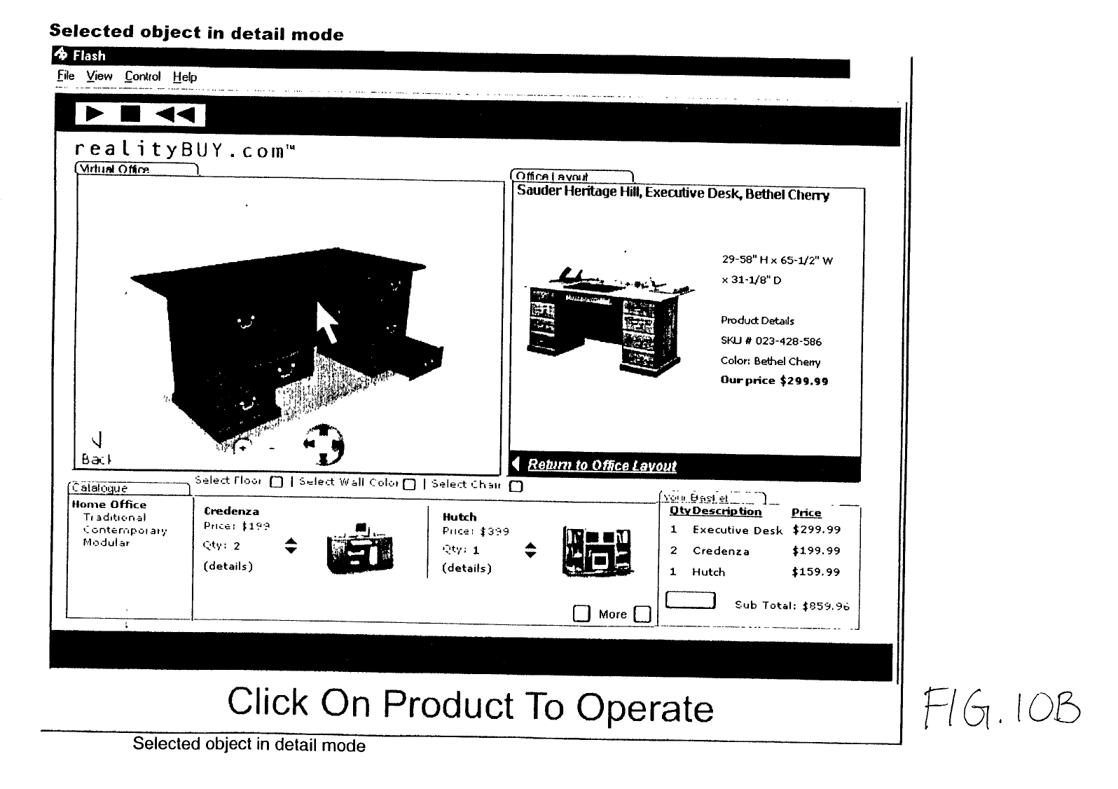

FIGS. 7A-B, both entitled “Layout configuration-position,” are exemplar of how a user can reposition products in the showroom invention. The user can select a product in the 2D multimedia viewer (“CO” as in FIG. 101) and use a mouse left click with continuous pressure, and while holding down the left click drag the product to any new location in the multimedia viewer. The multimedia viewer is updated in real time and an event signal is sent to the 3D viewer, which receives the event signal and updates continuously the position and orientation of the products as displayed in the 3D viewer (“B” as in FIG. 101). By illustration, the user in FIG. 7A has selected a product (e.g., a credenza) in the 2D multimedia viewer. The effect of dragging the product is illustrated in FIG. 7B in which the product location has been simultaneously updated in both the 3D viewer and the multimedia viewer. FIG. 8, entitled “Object selection in 3D,” is an exemplar of how a user can select a product from the 3D viewer. A user can left click on a product (e.g., in this example a desk in “B”, see FIG. 1), which causes an event signal to be sent to the multimedia viewer (see “C1” and “C0”, see FIG. 1). In real time upon receipt of the signal by the multimedia viewer the detailed image of the selected product appears in location “C1” (see FIG. 1). The user can then initiate an interactive encounter with the product in the multimedia viewer section as indicated (e.g., by use of a red border around the selected object).

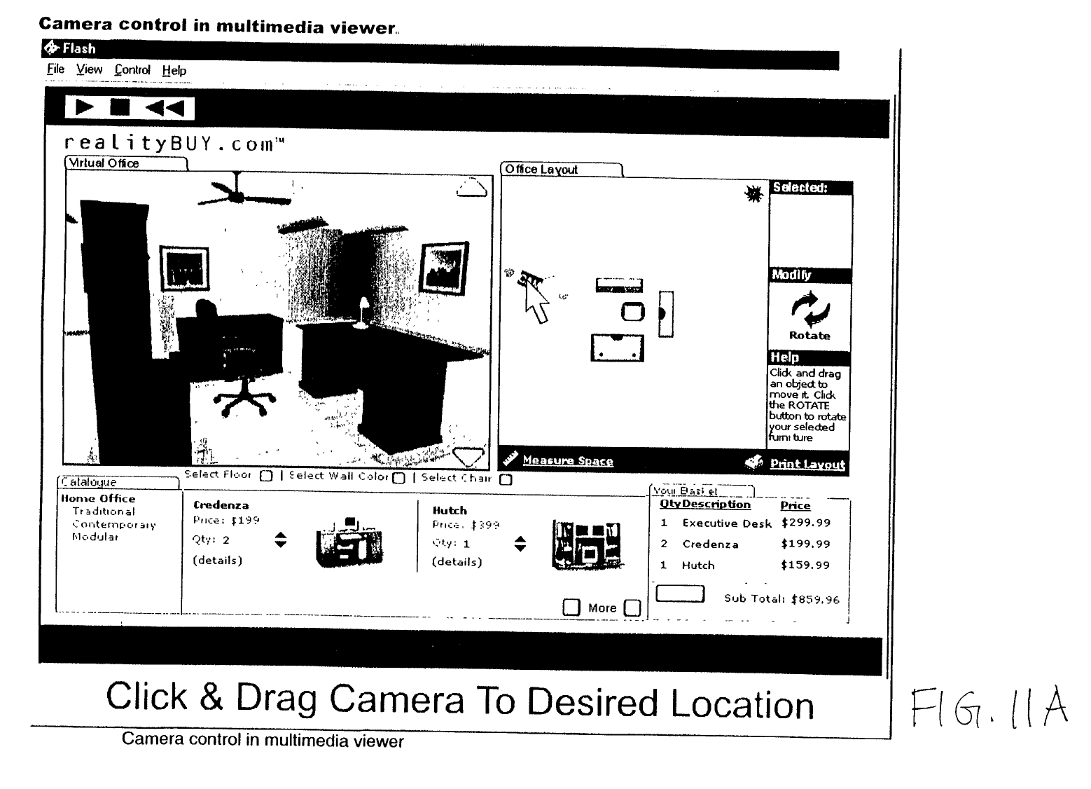

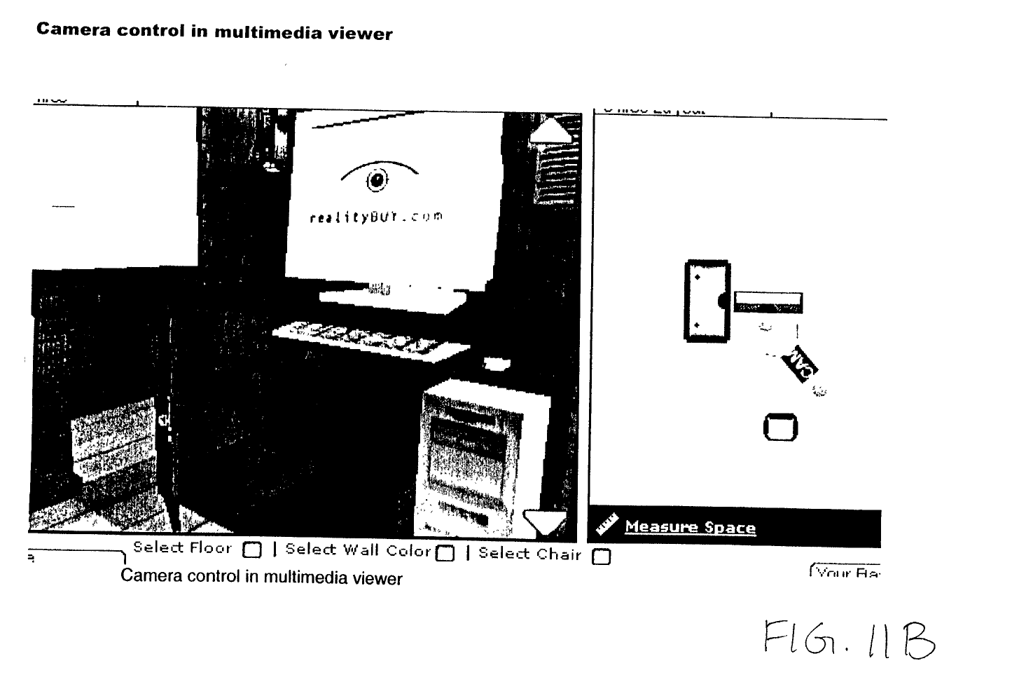

FIG. 9, entitled “Object selection in 3D and 2D,” and FIGS. 10A-B, all entitled “Selected object in detail mode,” are exemplar of how a user can obtain a detailed view and interaction with a selected product. A user may either (a) select a product image located in the web enabled language and/or other application language “A” (see FIG. 1) by using a left click, (b) select a product image located in the 3D viewer “B” (see FIG. 1) by using a right click or (c) select a product image located in the 2D multimedia viewer “C1” (see FIG. 1) (e.g., “selected” section) by using a left click. Any of the above selections initiate an event signal to be sent to the 3D viewer and the multimedia viewer. Upon receipt in real time of the event signal the 3D viewer and the multimedia viewer object images are updated to show an up close and detailed 3D simulation of the selected product. FIG. 10A shows a single selected product (e.g., a desk) isolated and in detail in the 3D viewer and in the 2D multimedia viewer as an isolated image with product data (e.g., dimensions, SKU number, color, price, etc.).

FIG. 10B shows the ability of a user to interact with the features of a product (e.g., a desk). The user can locate the cursor over the product's features in the 3D viewer and when the cursor changes to a “hand” or other icon then the feature (e.g., a desk drawer) of the product can be interactively demonstrated by using the left click button. This sends an event signal that triggers the feature to be activated to interactively demonstrate its features through animation or other means. To return to the multi-product display view a user can either right click on the product or left click on the return indicator.

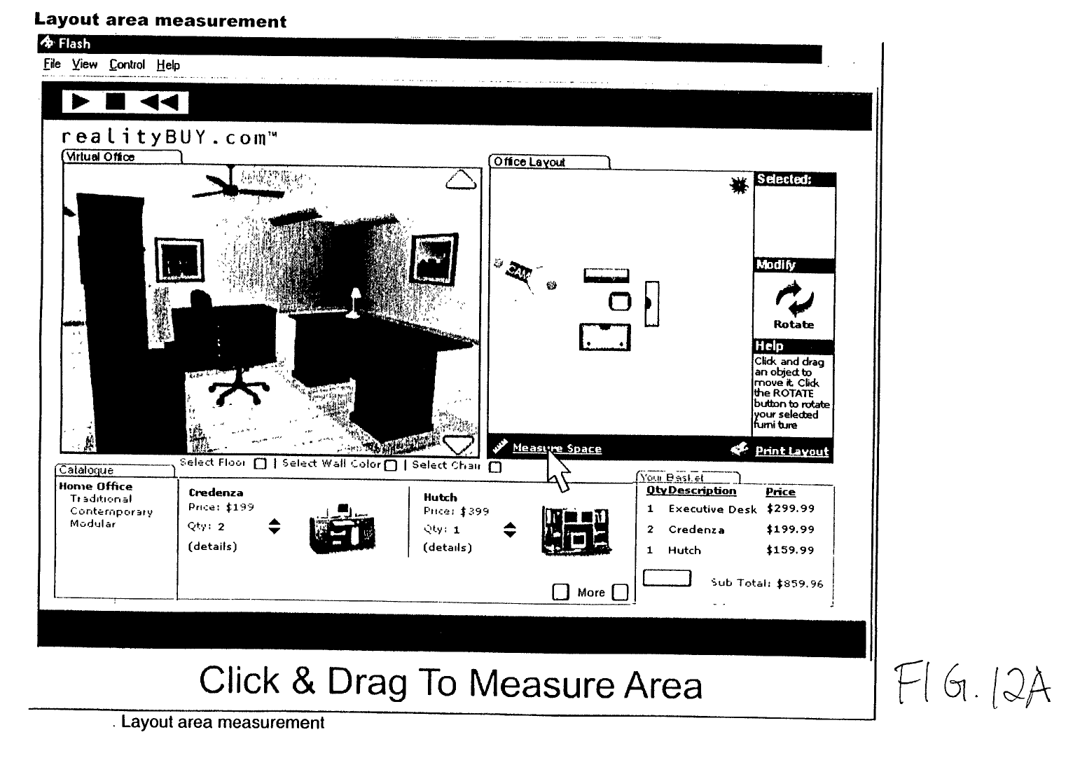

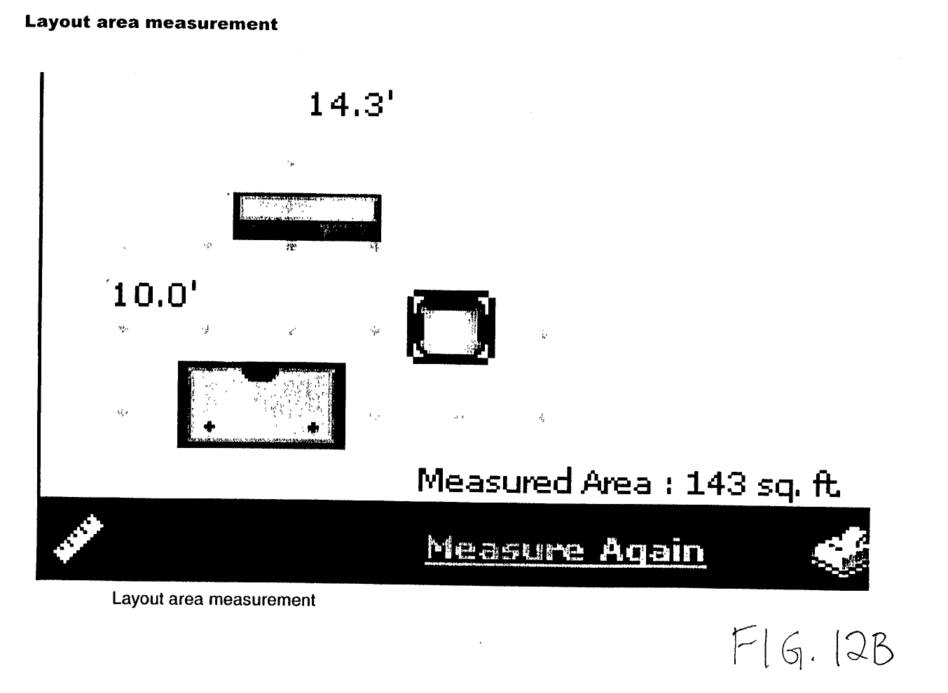

FIGS. 11A-B, entitled “Camera control in multimedia viewer,” are exemplar of how a user can select and control the view angle of products. FIG. 11A demonstrates that by left clicking on the camera icon (labeled “CAM” in “C”, see FIG. 101) located in the 2D multimedia viewer the user drag the camera to any location within the multimedia viewer section. By left clicking on either large dot located on the circle surrounding the camera icon the user can rotate the camera angle. This activity causes an event signal containing position and orientation data to be sent in real time to both the 3D viewer and the 2D multimedia viewer. This information is received and updated in real time by both the 3D viewer and the 2D multimedia viewer. FIG. 11A shows that the effect in real time of moving the camera from the position as indicated in FIG. 9 (e.g. a lower left comer location) to the location in FIG. 11A (a mid-left side of the viewer location) the products can be viewed from an entirely new angle. FIG. 11B shows the effect of the user moving the camera icon to a new location in the 2D multimedia viewer and the real time impact on the view in both the 3D viewer and the 2D multimedia viewer.

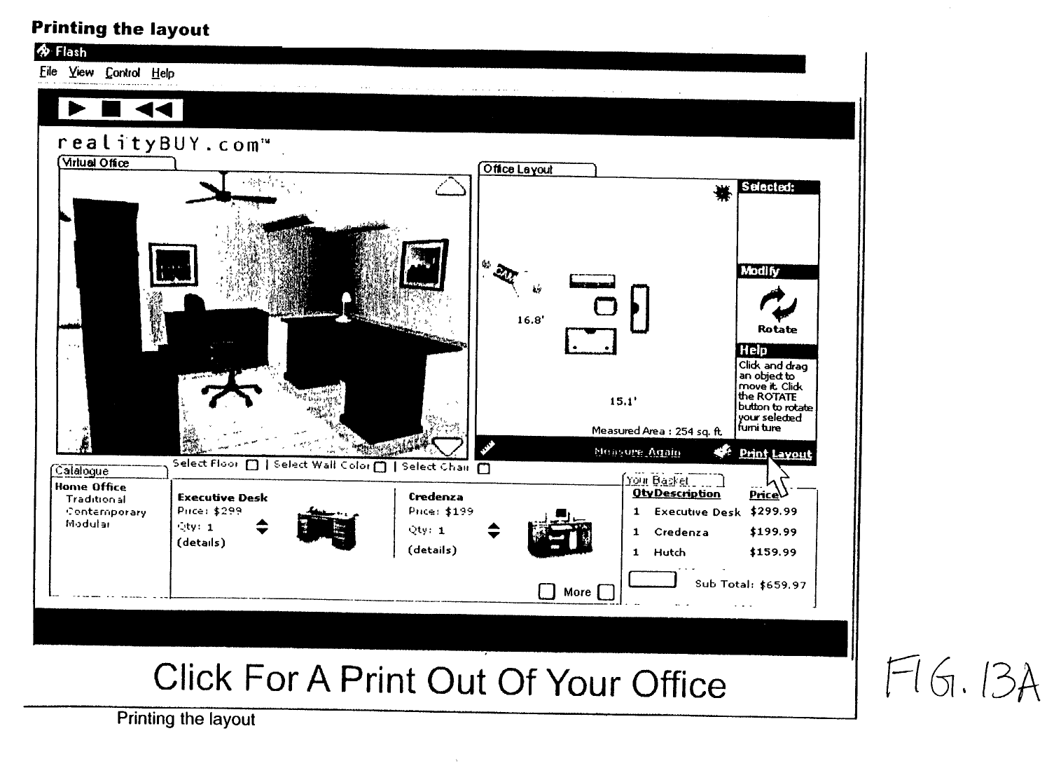

FIGS. 12A-B, entitled “Layout area measurement,” are exemplar of how a user can set the dimensions of the interactive showroom display, determine the measurements of the showroom and visualize the impact on the arrangement of the products located within the showroom's dimensions. FIG. 12A shows how the user initiates the process by left clicking on the “Measure Space” (“C3”, see FIG. 1) indicator. The user can place the cursor at any location within the 2D multimedia viewer, hold down the left mouse button and drag the mouse until the desired showroom dimensions have been achieved and release the button. The 2D multimedia viewer indicates the selected area by utilizing a darker shading and also in real time displays and updates the exact dimensions of the measured space as the user expands and contracts the dimensions. The multimedia viewer also specifies in real time the total volume of the measured area (e.g., in square feet) (see FIG.12B). FIG. 12A indicates how the user can then in real time manipulate the products as selected to fit in any way desired within the confines of the measured space dimensions within the 2D multimedia viewer. When the user drags the products in the multimedia viewer to new locations within the new dimensions of the showroom as selected, an event signal is simultaneously sent to both the 3D viewer and to the 2D multimedia viewer. The event signal is received in real time by the 3D viewer and the 2D multimedia viewer and the products are moved to the new locations as specified by the user. The measured space may also be indicated in the 3D viewer (e.g., by using a shading technique). The walls or other demarcation items utilized to indicated the boundaries of the simulation may also be made to change in real time in the 3D viewer to coincide with the measured space as indicated in the 2D multimedia viewer.

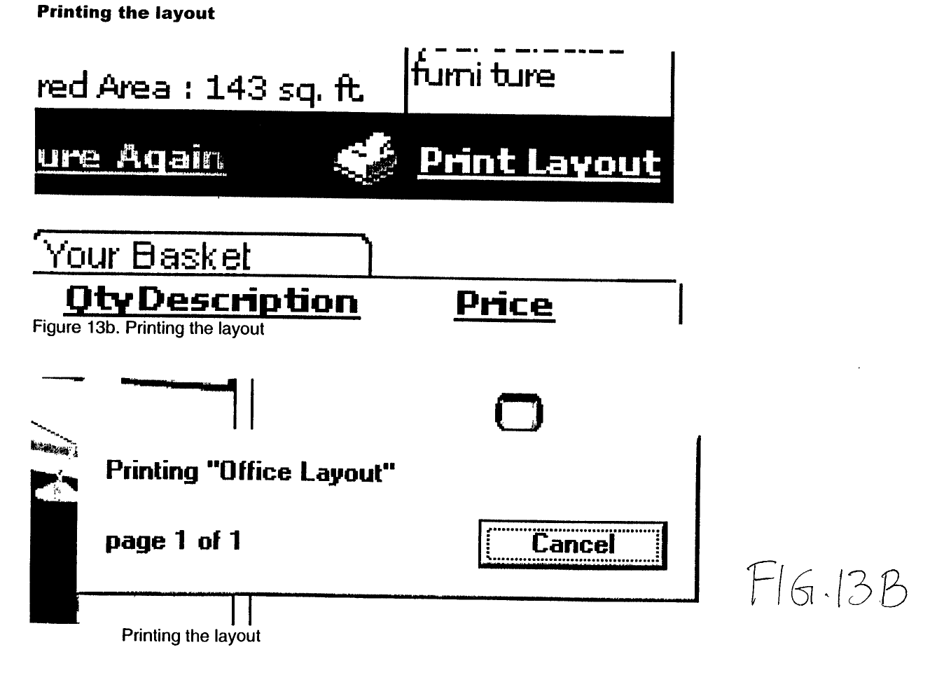

FIGS.13A-B, entitled “Printing the layout,” are exemplar of how a user can elect to print out an image of the 2D layout of the products as configured and selected. The user can left click the cursor on “Print layout” (“C4”, see FIG. 1) located in the 2D multimedia viewer. This causes an event signal to be sent within the 2D multimedia viewer to initiate the print sequence of the image located within the multimedia viewer. FIG. 13B indicates a confirmation from the multimedia viewer that the printing process has been initiated. The user may also print out the 3D viewer image (“B” in FIG. 1). The user may also print out the product description (“A” in FIG. 1). The user may also print out the “Your Basket” listing (“A1” in FIG. 1)

Similar to the showroom display illustrated in the above figures, the system and method of the present invention may also be used in other ways to display interactive, 3D products (i.e. not in a showroom display). According to one embodiment, in an interface similar to the one illustrated in the figures above, a product is displayed in the 3D viewer. A 2-D view of the product may or may not be displayed simultaneously. If the product is a motorcycle, for example, the user may select from a pre-defined list of components, to customize the motorcycle to the user's specifications. The changes will appear in real-time in the 3D viewer, and the user is thus able to view the motorcycle, as customized with the selected components, in real-time.

Thus, a real-time, three-dimensional, interactive, configurable display system and method is disclosed. Although the present invention has been described with reference to specific exemplary embodiments, it will be evident to those skilled in the art that various changes and modifications may be made to these embodiments, and equivalents may be substituted for elements in these embodiments, without departing from the general spirit and scope of the invention, as set forth in the claims. In addition, many modifications may be made to adapt a particular element, technique or implementation to the teachings of the present invention without departing from the central scope of the invention. Accordingly, the specification should be regarded in an illustrative rather than a restrictive sense.

I claim:

1. An interactive interface for configuring and displaying products in real-time, said interactive interface comprising:
a search mechanism retrieving a product from a data repository according to predefined criteria; and
a three-dimensional viewer displaying a three-dimensional view of said product.

2. The interactive interface according to claim 1 further comprising a two-dimensional viewer displaying a two-dimensional view of said product, wherein said two-dimensional view of said product corresponds to said three-dimensional view of said product.

3. The interactive interface according to claim 1 wherein said search mechanism additionally retrieves from said data repository a price associated with said product.

4. The interactive interface according to claim 1 further comprising a procurement system coupled to said data repository.

5. The interactive interface according to claim 1 further comprising a real-time cumulative total of price for said product.

6. The interactive interface according to claim 2 wherein a manipulation of said three-dimensional view of the product results in a similar manipulation of said two-dimensional view of said product.

7. The interactive interface according to claim 2 wherein a manipulation of said two-dimensional view of the product results in a similar manipulation of said three-dimensional view of said product.

8. The interactive interface according to claim 1 wherein said data repository is a relational database.

9. The interactive interface according to claim 1 wherein said predefined criteria includes a style of said product.

10. The interactive interface according to claim 1 wherein said data repository is an external data repository.

11. The interactive interface according to claim 10 wherein said external data repository is an Enterprise Resource Planning system.

12. The interactive interface according to claim 10 wherein said external data repository is a relational database.

13. The interactive interface according to claim 10 wherein said external data repository is coupled to the interactive interface via the Internet.

14. The interactive interface according to claim 1 wherein said data repository is a local data repository and is updated periodically from a remote data repository via the Internet.

15. The interactive interface according to claim 1 wherein said predefined criteria includes a category of said product.

16. An interactive method for configuring and displaying a product display in real-time, comprising the steps of:
retrieving a product from a data repository in response to input from a user;
configuring said product in real-time according to instructions from said user; and
displaying a three-dimensional, real-time view of said product.

17. The method according to claim 16 further comprising the step of:
displaying a two-dimensional real-time view of said product corresponding to said three-dimensional, real-time view of said product.

18. The method according to claim 17 wherein a manipulation of said three-dimensional, real-time view of said product results in a manipulation of said two-dimensional, real-time view of said product.

19. The method according to claim 18 wherein a manipulation of said three-dimensional, real-time view of said product results in a manipulation of said two-dimensional, real-time view of said product.

20. The method according to claim 19 further comprising the step of identifying prices of said product from said data repository.

21. The method according to claim 20 further comprising the step of coupling said product and said prices to a procurement system.

22. The method according to claim 20 further comprising the step of displaying a realtime total of said prices for said product.

23. The method according to claim 16 wherein said data repository is accessed via the Internet.

24. The method according to claim 16 wherein said data repository is a local data repository and is updated periodically from a remote data repository via the Internet.
